(19) United States
(12) Patent Application Publication
(10) Pub. No.: US 2011/0284779 A1
(43) Pub. Date: Nov. 24, 2011

(54) METHOD AND APPARATUS FOR CONTROLLING A HIGH-PRESSURE VALVE

(75) Inventor: Göran Cewers, Limhamn (SE)

(73) Assignee: MINDRAY MEDICAL SWEDEN AB, Sundbyberg (SE)

(21) Appl. No.: 13/108,801

(22) Filed: May 16, 2011

Related U.S. Application Data
(60) Provisional application No. 61/345,797, filed on May 18, 2010.

(51) Int. Cl. F16K 47/00; F16K 31/02

(52) U.S. Cl. 251/118; 251/129.01

(57) ABSTRACT

A system and a method are described for converting a small motion from a piezoelectric actuator to a larger motion in a valve mechanism. A piezoelectric actuator is connected in series to a mechanical amplifier, and, optionally, a mechanical temperature compensation element and a mechanical fine tuning element, all acting in the same effective direction as the piezoelectric actuator.

### CROSS-REFERENCE TO RELATED APPLICATION(S)

This application claims the benefit of U.S. Provisional Application No. 61/345,797, filed May 18, 2010, which is incorporated herein by reference.

### TECHNICAL FIELD

The following disclosure relates to valves.

### SUMMARY OF THE INVENTION

A piezoelectrically controlled high pressure valve is disclosed, as well as a method of converting a small motion, such as from a piezoelectric actuator, to a larger motion that may control a valve mechanism.

### BRIEF DESCRIPTION OF THE DRAWINGS

FIG. 1 is a schematic view of an exemplary embodiment of a piezoelectric valve.

### DETAILED DESCRIPTION

Piezo ceramics are being increasingly used in actuator applications where they are superseding electromagnetic solutions. One reason for this is that the force relative to intrinsic mass is approximately ten times greater with piezoelectric ceramic techniques compared with electromagnetic techniques. An example of where electromagnets have been replaced by piezo actuators is fuel injection valves in the car industry. This has led to a new generation of car engines with lower fuel consumption and emissions. The reason is that piezo actuator technology makes it possible to control fuel injection almost to the millisecond for each piston stroke.

Unfortunately, replacing electromagnets with piezo actuators is not entirely straightforward, as extremely little amplitude of movement is generated by the latter, even if the force is great. Thus, the motion generated by piezo actuators must be amplified. Moreover, piezoelectric actuators have extremely low thermal expansion coefficients, which, at first sight, may seem an advantage, but it is a problem as the surrounding material acting as a mechanical reference point to the piezoelectric actuator must also have an extremely low thermal expansion coefficient. Very few materials possess this property, and even fewer materials may be suitable based on other considerations, such as processivity, corrosion, price, durability, etc. Yet another problem with the piezo ceramic technology is that the tolerances of the parts are often several times larger than the motion amplitude they are able to create. This creates the need for mechanical fine tuning.

Even if large forces are generated by piezoelectric actuators, it should be noted that the movement is extremely small. Any amplification of motion results in an equivalent reduction in force. For this reason, a high pressure valve should be designed so that the inlet pressure has as little impact as possible on the valve seat.

In U.S. Pat. No. 5,265,594, a high pressure valve is disclosed having a valve mechanism at the end of a tube with a spring tensioned soft seat pressing against the tube end. The cross-sectional area of the entire tube will contribute to a force caused by the inlet pressure, a force that the above-mentioned spring must resist, and a force which the electromagnet must overcome. As a result, a large, strong, expensive and energy-guzzling electromagnet is needed in this design.

The disclosure relates to a piezoelectrically controlled high pressure valve that depends little on the inlet pressure. According to one aspect of the disclosure, an actuator-controlled high pressure valve is provided with a valve inlet and a valve outlet. The high pressure valve may include a piezoelectric actuator, a mechanical amplification element, and a valve mechanism acting on a valve seat. The actuator, the mechanical amplifier element, and the valve mechanism may be arranged along a common axis. The actuator may be designed to generate a motion for controlling the valve mechanism, and the mechanical amplifier element is arranged to amplify the motion of the actuator to the valve mechanism's closing or opening motion.

The disclosed high pressure valve design allows one to exploit the advantages of piezo technology as opposed to, e.g., electromagnetic technology. One also avoids the issues that are still associated with the small movements of piezo actuators and their low thermal expansion coefficients.

This solution is provided, in one embodiment, by connecting at least one actuator unit in series to at least one mechanical amplifier element, which boosts the actuator unit's amplitude, which can then control a valve to open or close.

In another embodiment of the disclosure, the actuator-controlled high pressure valve comprises a first flow resistance element, which is positioned between the valve seat and the valve outlet. The flow resistance element is used to equalize the pressure of the flow, among other things, by helping to prevent turbulence and increasing the dynamic flow range. It can also be used together with a differential pressure gauge as a flow meter element.

In another embodiment of the actuator-controlled high pressure valve, the differential pressure gauge is connected upstream and downstream of the flow resistance element respectively.

In this design, the differential pressure becomes a signal which can be linearized and compensated for pressure, fluid type, and temperature, to obtain a measure of fluid flow. Such extra parameters can be measured and the measurement data used to linearize the flow values.

In yet another embodiment of the actuator-controlled high pressure valve, at least one other flow resistance element is placed downstream of the first flow resistance element.

This second flow resistance element may have the same function as the first, i.e., to equalize the fluid pressure through the channel and prevent turbulence and increase the dynamic flow area, or to be used as a flow measurement element. Here, the flow resistance elements may take the shape of a cylindrical tube or a cone. The device may also be designed so that the flow channel downstream of the outside of the first flow resistance element decreases in width.

In another embodiment of the actuator-controlled high pressure valve, at least one thermal expansion element is connected in series to the actuator. This additional unit is used to adjust the actuator in order to compensate for temperature dependent expansion of surrounding design elements.

In another embodiment of the actuator-controlled high pressure valve, at least one mechanical fine tuning element is connected in series to the actuator. The mechanical fine tuning element is used to correctly adjust the stroke length of the actuator relative to the other units of the design. This is important, since the tolerance of piezo actuators is often several times higher than the motion amplitude they can generate.

Another aspect of the disclosure includes a method for controlling a high pressure valve where all relevant components are connected in series along a common axis. The method may include the valve being controlled by a piezoelectric actuator with a stroke length that is amplified by a mechanical amplifier element to a valve mechanism acting on a valve seat. The method may also include generating a motion with the actuator, transmitting the motion to the mechanical amplifier element, and controlling the valve mechanism with the amplified motion to a closing or opening motion in the valve mechanism. If needed, the method may include fine tuning the valve with a mechanical fine tuning element and temperature compensating the motion with a thermal expansion element.

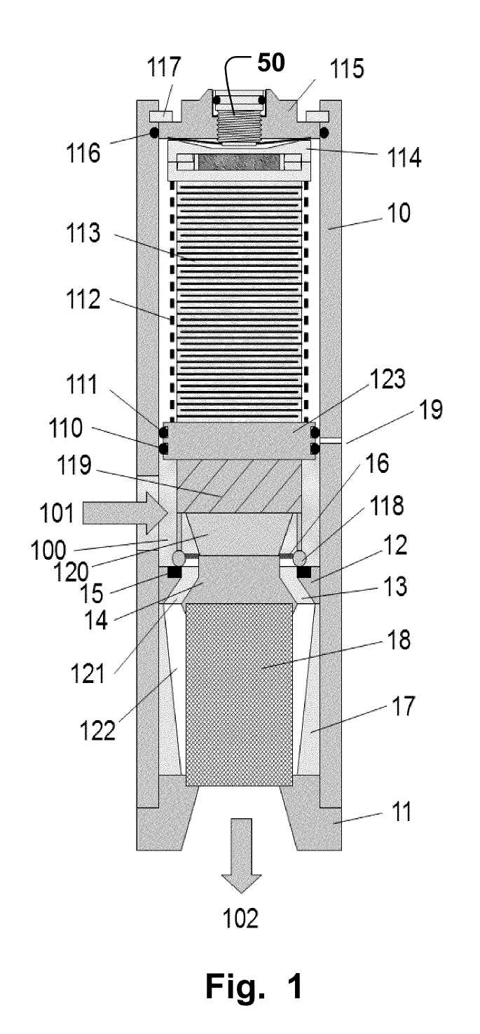

FIG. 1 shows a schematic view of an exemplary embodiment of a piezoelectric valve. From the outside, the valve may include a tube 10 with an inlet channel 101, outlet channel 102, and a fine tuning screw 50 on a mechanical fine tuning element 115.

Inside tube 10, the following may be included: a mechanical fine tuning element, a mechanical heat expansion element 114, a piezo actuator 113 enclosed by a pre-tension tube 112, a buffer disc 123, mechanical amplifier 119, a valve mechanism 118, a valve seat 15, and flow measurement net 18 in series. Mechanical fine tuning element 115 may be fastened in tube 10 with a spring ring 117 and may be sealed from the surroundings with an O-ring 116.

Buffer disc 123 acts as a sealing washer and moveable element between piezo actuator 113 and high pressure cavity 100. O-rings 110 and 111 act as seals against tube 10 and flexible elements for the motion of buffer disc 123. A ventilation channel 19 runs through tube 10 to the space between O-rings 110 and 111.

The mechanical amplifier 119 is exposed to a motion from buffer disc 123, which presses it against foundation disc 120. A compensation membrane 16 may be trapped between foundation disc 120 and flow channel disc 14. The outer edge of the compensation membrane may be fastened in valve mechanism 118.

Flow channel disc 14 has through channels to the interior of the flow channel disc's outer part 12, which holds the soft valve seat 15.

In one embodiment, parts 120, 12, 14, 15, and tube 10 are mechanically permanently connected with each other.

A gas permeable tube 18 may be trapped between flow channel disc 14 and end piece 11.

A volume reducing tube with a conically shaped interior may be disposed between the tube 10 and the gas permeable pipe 18. The volume reducing tube 17 may be an integral part of tube 10.

The function of ventilation channel 19 is that, upon leakage from high pressure cavity 100 past O-ring 110, the gas should leak out through the ventilation hole 19. Due to ventilation hole 19, the O-ring 111 is not exposed to high pressures. Thus, leakage from the high pressure cavity is prevented up to piezo actuator 113. This may, for example, be advantageous in explosion-sensitive environments where it is important that the piezo actuator does not come in contact with the surroundings, or for preventing moist gas leaking into the actuator.

In operation, the device may function as follows. A voltage applied to piezo actuator 113 causes it to expand and the actuator continues to move up to buffer disc 123, which then presses the mechanical amplifier 119 against the foundation disc 120. The valve mechanism 118 is then raised from valve seat 14 with the actuator motion multiplied by the amplification of mechanical amplifier 119. Gas then flows through the channels of flow channel disc 14 down into the narrowed-down channel 122 and then on through gas permeable tube 18. A differential pressure gauge, not shown in the FIGURE, may be connected to channel 122 and under gas permeable tube 18, respectively. The differential pressure is then converted to a signal, which may be linearized and compensated for pressure, gas type, and temperature to provide a measure of the gas flow.

The inside of gas permeable duct 18 can be lined with a foil having slit openings (according to a co-pending application of the Assignee entitled “FLOW RESTRICTOR AND A METHOD TO REDUCE RESISTANCE OF A FLOW,” filed on May 18, 2010, as U.S. Provisional Application No. 61/345,788, which is incorporated herein by reference), in order to reduce the differential pressure during high flows and thus increase the dynamics of flow measurement.

In the closed state, the inlet gas pressurizes high pressure cavity 100 and also the top of compensation membrane 16, since the connection between mechanical amplifier 119 and valve mechanism 118 comprises narrow linking elements. At high pressures in the closed position, the inlet gas endeavours to leak between valve mechanism 118 and valve seat 15. However, at the same time, the pressure gives rise to a force above compensation membrane 16, which presses valve mechanism 118 harder against valve seat 15. This prevents leakage when inlet pressures are high. This allows the power, size, and price of the actuator to be reduced.

In another embodiment, the actuator-controlled high pressure valve comprises a first flow resistance element, which is placed between the valve seat and the valve outlet, such as flow measurement net 18. The first flow resistance element is used here to equalize the pressure of the flow, among other things, by assisting to prevent turbulence and increasing the dynamic flow range. It can also be used together with a differential pressure gauge as a flow meter element.

In yet another embodiment of the actuator-controlled high pressure valve, at least one other flow resistance element (not shown) is placed downstream of the first flow resistance element. This second flow resistance element has the same function as the first, i.e., to equalize the fluid pressure through the channel and prevent turbulence and increase the dynamic flow range, or to be used as a flow measurement element. Here, the flow resistance element may take the shape of a cylindrical tube or a cone. The device may also be designed so that the flow channel downstream of the outside of the first flow resistance element decreases in width.

The principles described above are beneficial in combination with actuators with a small range of motion. Moreover, in the case of piezo actuators, combinations may be made with other types of actuators, such as electrostrictive, thermal or chemical actuators.

Without further elaboration, it is believed that one skilled in the art can use the preceding description to utilize the present disclosure to its fullest extent. The examples and embodiments disclosed herein are to be construed as merely illustrative and not a limitation of the scope of the present disclosure in any way. It will be apparent to those having skill in the art that changes may be made to the details of the above-described embodiments without departing from the underlying principles of the disclosure described herein. In other words, various modifications and improvements of the embodiments specifically disclosed in the description above are within the scope of the appended claims. The scope of the invention is, therefore, defined by the following claims. The words “including” and “having,” as used herein, including the claims, shall have the same meaning as the word “comprising.”

What is claimed is:

1. An actuator-controlled high pressure valve having a valve inlet and a valve outlet, comprising:
a piezoelectric actuator;
a mechanical amplification element; and
a valve mechanism acting on a valve seat;
wherein the actuator, the mechanical amplifier element, and the valve mechanism are arranged along a common axis, wherein the actuator is arranged to generate a motion for controlling the valve mechanism, and the mechanical amplifier element is arranged to amplify the motion of the actuator to a closing or opening motion of the valve mechanism.

2. The high pressure valve of claim 1, wherein the valve is arranged in a tube with a valve inlet and a valve outlet.

3. The high pressure valve of claim 1, wherein a first flow resistance element is arranged between the valve seat and the valve outlet.

4. The high pressure valve of claim 3, wherein a differential pressure gauge is connected upstream and downstream of the flow resistance element respectively.

5. The high pressure valve of claim 3, wherein a second flow resistance element is arranged downstream of the first flow resistance element.

6. The high pressure valve of claim 3, wherein the first flow resistance element has a shape of a cylindrical tube or a cone.

7. The high pressure valve of claim 3, wherein a flow channel downstream of the outside of the first flow resistance element decreases in width.

8. The high pressure valve of claim 1, wherein a thermal expansion element is connected in series to the actuator.

9. The high pressure valve of claim 1, wherein at least one mechanical fine tuning element is connected in series to the actuator.

10. The high pressure valve of claim 1, wherein two seals are arranged between the actuator and the mechanical amplification element, and wherein a ventilation channel is arranged between the two seals.

11. A method for controlling a high pressure valve where all included components are connected in series along a common axis, said method comprising the valve being controlled by a piezoelectric actuator with a stroke length which is amplified by a mechanical amplifier element to a valve mechanism acting on a valve seat, and wherein said method comprises generating a motion with the actuator, transmitting the motion to the mechanical amplifier element, and controlling the valve mechanism with the amplified motion to a closing or opening motion in the valve mechanism.

12. The method of claim 11, further comprising fine tuning the valve with a mechanical fine tuning element.

13. The method of claim 11, further comprising temperature compensating the motion with a thermal expansion element.
